(19) United States
(12) Patent Application Publication
(10) Pub. No.: US 2017/0240388 A1
(43) Pub. Date: Aug. 24, 2017

(54) HITCH ASSEMBLY FOR A MACHINE

(71) Applicant: Caterpillar Inc., Peoria, IL (US)

(72) Inventors: Mitchell Gray Heinzmann, Durham, NC (US); Gerald Michael Fuerst, Cary, NC (US); Andrew R. Fowkes, Clayton, NC (US); Bradley Robert Lancaster, Raleigh, NC (US); Troy Lee Evans, Selma, NC (US)

(73) Assignee: Caterpillar Inc., Peoria, IL (US)

(21) Appl. No.: 15/050,559

(22) Filed: Feb. 23, 2016

(51) Int. Cl. B66C 1/66; B60B 27/00; B60R 9/02; B62D 33/00

(52) U.S. Cl. CPC B66C 1/66; B62D 33/00; B60B 27/0047; B60R 9/02; E02F 3/283

(57) ABSTRACT

A hitch assembly to hoist a machine having at least one wheel rim includes a mounting flange configured to be disposed on an outer face of the wheel rim; and a hitch protruding from the mounting flange and extending longitudinally away from the outer face of the wheel rim. The hitch assembly further includes an elongated receiver component selectively coupled to the hitch, the receiver component having a first end adapted to releasably engage with the hitch; and a hook element rotatably coupled to a second end of the receiver component, the hook element being configured to rotate about the receiver component.

### TECHNICAL FIELD

The present disclosure relates to systems for transportation of a machine. More particularly, the present disclosure relates to a hitch assembly for hoisting a machine for e.g., a wheeled machine.

### BACKGROUND

Many applications such as for e.g., stevedoring require machines for e.g., construction or earth-moving equipment to be transported using hoisting systems. In some cases, it may be required to hoist and lower such machines several times in a day with the help of a hoisting system. Manufacturers of such machines typically provide one or more lifting points or fixtures on the machine to couple with the hoisting system and help in execution of the hoisting and lowering functions.

However, in many cases it has been observed that such lifting points have been previously located on components of the machine that exhibit inadequate strength to perform repeated lifting of the machine. In other cases, such lifting points or fixtures were also permanently affixed on the machine thus increasing initial costs of the machine to an end user or customer. However, a service life of such lifting points or fixtures may still be finite thus allowing use of the lifting points or fixtures only for a limited period of time.

In yet other cases, conventional lifting points or fixtures previously implemented on machines also entailed the use of unequal lengths of the ropes, wires, or chains of the hoist system. However, such lifting points or structures and the resultant use of unequal lengths of the ropes, wires, or chains of the hoist system could be ineffective in maintaining equilibrium in the balance of the machines as the machines are being hoisted or lowered.

PCT Publication WO 2007/015381 (hereinafter referred to as the '381 publication) discloses a lifting tool for a vehicle that is capable of safely and reliably lifting the vehicle by using reduced number of parts without damaging the vehicle. A hub tool has long nut members each connected at one end by threads to each hub bolt projected from a hub for fixing a wheel, and also has a plate member having a support plate member to one side of which the other end of each long nut member is fastened and fixed by a fixing screw and also having an engagement section projected to the other face side of the support plate member. In the engagement section, an engagement tool is pivotally attached to an engagement hole by a support pin. The engagement tool is inserted and fixed in an engagement hole formed in an end of a lifting belt.

Although the lifting tool disclosed in the '381 publication holds some promise in maintaining equilibrium in the balance of the machine by providing the lifting points alongside wheels of the machine, the lifting tool of the '381 publication may be bulky adding to increased costs and weight of the machine.

Hence, there is a need for a system that is simplified, low-cost, and effective while also serving to overcome the aforementioned shortcomings typically associated with use of previously known lifting points or fixtures for hoisting or lowering machines. Further, there is a need for a light-weight system that can be left on the machine when not in use while also allowing an operator or a technician to quickly utilize the system present on the machine for hoisting or lowering the machine.

### SUMMARY OF THE DISCLOSURE

In an aspect of the present disclosure, a hitch assembly to hoist a machine having at least one wheel rim includes a mounting flange configured to be disposed on an outer face of the wheel rim; and a hitch protruding from the mounting flange and extending longitudinally away from the outer face of the wheel rim. The hitch assembly further includes an elongated receiver component selectively coupled to the hitch, the receiver component having a first end adapted to releasably engage with the hitch; and a hook element rotatably coupled to a second end of the receiver component, the hook element being configured to rotate about the receiver component.

In another aspect of the present disclosure, a machine includes a frame; and at least one wheel assembly rotatably supported on the frame, the wheel assembly comprising a wheel rim having an outer face and an outer lip extending angularly away from the outer face. The machine also includes a hitch assembly coupled to the wheel rim. The hitch assembly includes a mounting flange configured to be disposed on an outer face of the wheel rim; and a hitch protruding from the mounting flange and extending longitudinally away from the outer face of the wheel rim. The hitch assembly further includes an elongated receiver component selectively coupled to the hitch, the receiver component having a first end adapted to releasably engage with the hitch; and a hook element rotatably coupled to a second end of the receiver component, the hook element being configured to rotate about the receiver component.

In yet another aspect of the present disclosure, a method of hoisting a machine having at least one wheel rim includes coupling a mounting flange to an outer face of the wheel rim, wherein a hitch protrudes from the mounting flange and extends longitudinally away from the outer face of the wheel rim. The method further includes selectively coupling an elongated receiver component to the hitch, the receiver component having a first end adapted to releasably engage with the hitch, wherein a hook element is rotatably coupled to a second end of the receiver component. The method further includes releasably coupling the hook element with a hoist for hoisting the machine.

Other features and aspects of this disclosure will be apparent from the following description and the accompanying drawings.

### BRIEF DESCRIPTION OF THE DRAWINGS

FIG. 1 is a side view of an exemplary machine, in accordance with an embodiment of the present disclosure;

FIG. 2 is an exploded view of a wheel assembly of the machine from FIG. 1 showing a hitch assembly coupled thereto, in accordance with an embodiment of the present disclosure;

FIG. 3 is a partially exploded view of the wheel assembly and the hitch assembly from FIG. 2, in accordance with an embodiment of the present disclosure;

FIG. 4 is an assembled view of the wheel assembly and the hitch assembly from FIG. 2, in accordance with an embodiment of the present disclosure;

FIG. 5 is a cut-away view of the wheel assembly showing a hitch assembly in an assembled configuration, in accordance with another embodiment of the present disclosure;

FIG. 6 is a cut-away view of the wheel assembly and the hitch assembly from FIG. 5 showing an inter-relationship of dimensions, in accordance with another embodiment of the present disclosure;

FIGS. 7a-7b are partially sectioned views of the hitch assembly showing a receiver component telescopically movable with respect to a hitch of the hitch assembly, in accordance with another embodiment of the present disclosure; and

FIG. 8 is a flow chart depicting a method of hoisting a machine having at least one wheel rim, in accordance with embodiments of the present disclosure.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

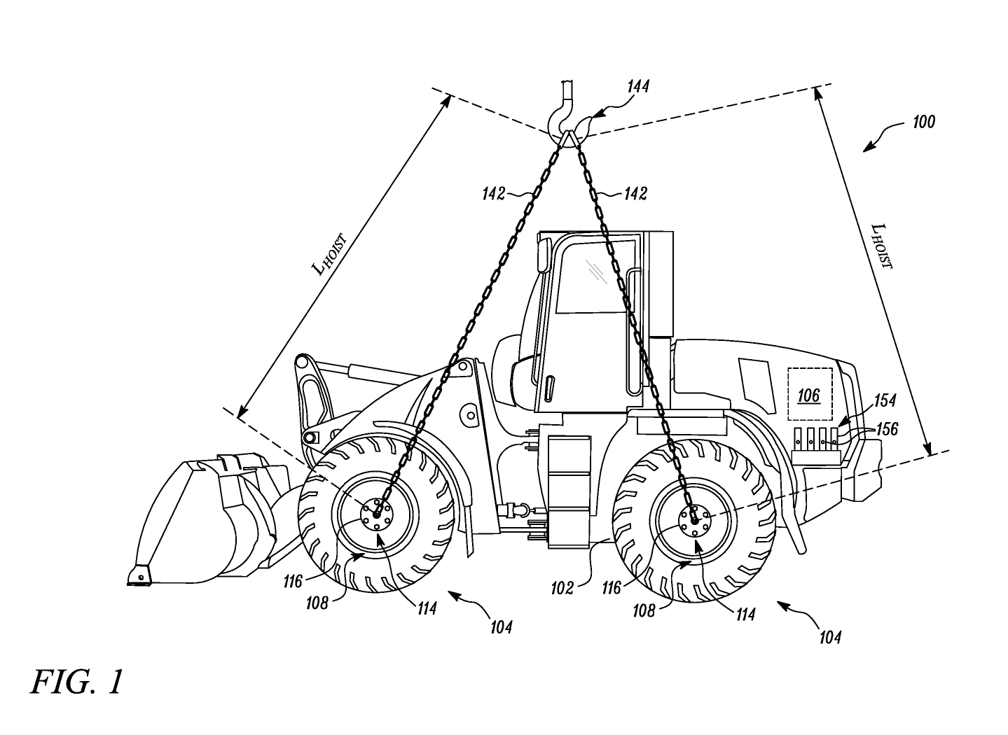

The present disclosure relates to a hitch assembly 114 for hoisting a machine 100. FIG. 1 shows an exemplary machine 100 in which embodiments of the present disclosure can be implemented. As shown, the machine 100 is embodied in the form of a small wheel loader (SWL) that is typically used to move earth materials from one location to another. However, it may be noted that the SWL disclosed herein is exemplary and hence, non-limiting of this disclosure. One skilled in the art will appreciate that systems and methods disclosed herein can be similarly applied to numerous other types of machines, mobile or stationary, without deviating from the spirit of the present disclosure. Some examples of mobile machines may include machines that are wheeled or tracked, but is not limited to, tractors, trailers, excavators, mining trucks, dump trucks, large wheel loaders (LWL), and passenger cars. Moreover, such machines may be used in applications including, but not limited to, forestry, agriculture, mining, construction, transportation and the like. Additionally, some examples of stationary machines could include gas turbine engines, generator sets, and other types of turbomachines known in the art, but is not limited thereto.

With continued reference to FIG. 1, the machine 100 includes a frame 102 having at least one wheel assembly 104 rotatably supported thereon. Two wheel assemblies 104 have been shown in the exemplary machine 100 of FIG. 1. Two additional wheel assemblies (not shown) are also present on the other side of the machine 100. However, it may be noted that a number of wheel assemblies is merely exemplary in nature. Systems and methods can be similarly applied to other types of machines having fewer or more wheel assemblies. Each of the wheel assemblies 104 may be rotated using drive power from a power source 106 of the machine 100. In an embodiment, the power source 106 may be an engine. In another embodiment, the power source 106 may be an electric motor. However, one of ordinary skill in the art will acknowledge that a type of prime source disclosed herein is exemplary in nature and hence, non-limiting of this disclosure. Any type of prime source known in the art may be used in lieu of the engine and the electric motor disclosed herein.

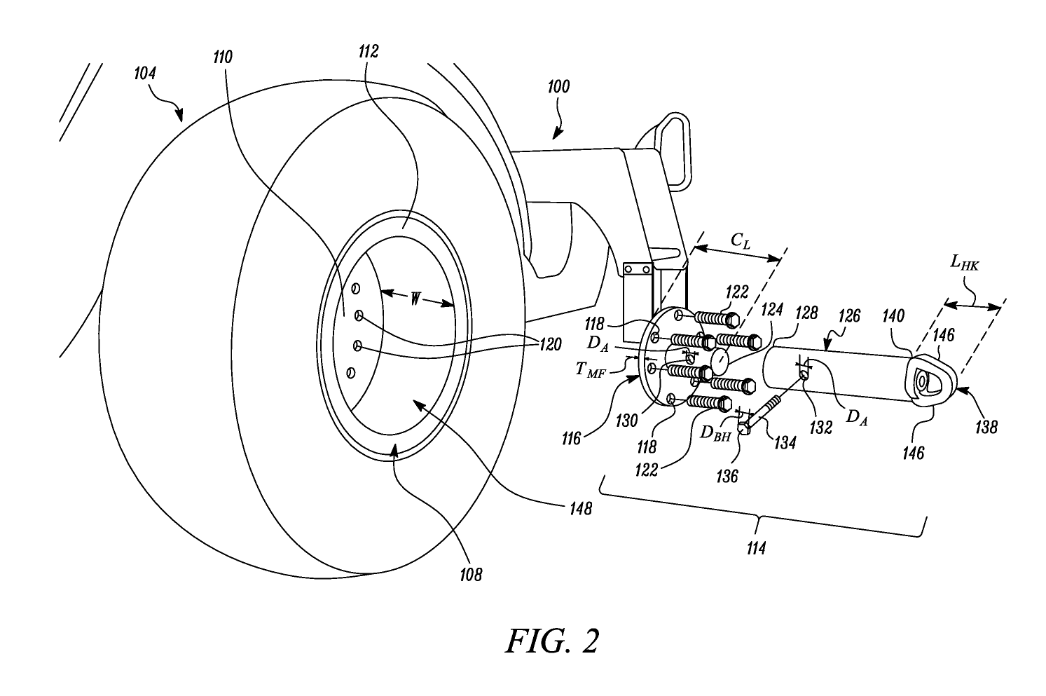

As shown in FIG. 2, the wheel assembly 104 includes a wheel rim 108 having an outer face 110 and an outer lip 112 extending angularly away from the outer face 110. For tracked machines or vehicles, embodiments disclosed herein may be similarly implemented on a toothed roller or a toothed idler (not shown) of the tracks. Therefore, notwithstanding anything contained in this document, it may be noted that systems disclosed herein can be implemented in various types of machines and/or applications without limiting the scope of the appended claims.

The machine 100 also includes a hitch assembly 114 coupled to the wheel rim 108 of each wheel assembly 104. Explanation pertaining to the hitch assembly 114 will be made hereinafter in conjunction with one of the wheel assemblies 104 present in the machine 100. Referring to FIGS. 2-4, the hitch assembly 114 includes a mounting flange 116 configured to be disposed on the outer face 110 of the wheel rim 108. In the embodiment illustrated in FIG. 2, the mounting flange 116 has holes 118 that correspond with holes 120 defined on the outer face 110 of the wheel rim 108. As these holes 118 are configured to mutually align with the holes 120 on the outer face 110 of the wheel rim 108, the holes 118, 120 when aligned with each other can allow fasteners 122 to be inserted therein and releasably engage the mounting flange 116 to the outer face 110 of the wheel rim 108. The fasteners 122 could include for e.g., lug bolts.

In an embodiment as best shown in FIG. 2, the holes 120 on the outer face 110 of the wheel rim 108, to which holes 118 defined in the mounting flange 116 are configured to align, may be holes that are typically provided to couple the wheel rim 108 to an axle hub (not shown) of the machine 100. Alternatively, a unique set of holes or special-purpose holes (not shown) may be defined on the outer face 110 of the wheel rim 108 for coupling the mounting flange 116. Such unique set of holes may be equidistantly located from a center C on the outer face 110 of the wheel rim 108. Various other configurations of holes may be contemplated by persons skilled in the art on the outer face 110 of the wheel rim 108 to allow coupling of the mounting flange 116 to the outer face 110 of the wheel rim 108 depending on specific requirements of an application.

In another embodiment, it can also be contemplated to form the mounting flange 116 of the hitch assembly 114 integrally with the outer face 110 of the wheel rim 108. For example, the mounting flange 116 may be welded onto the outer face 110 of the wheel rim 108. Such configurations can be contemplated by persons skilled in the art without deviating from the spirit of the present disclosure so that the mounting flange 116 is rendered integral with the outer face 110 of the wheel rim 108.

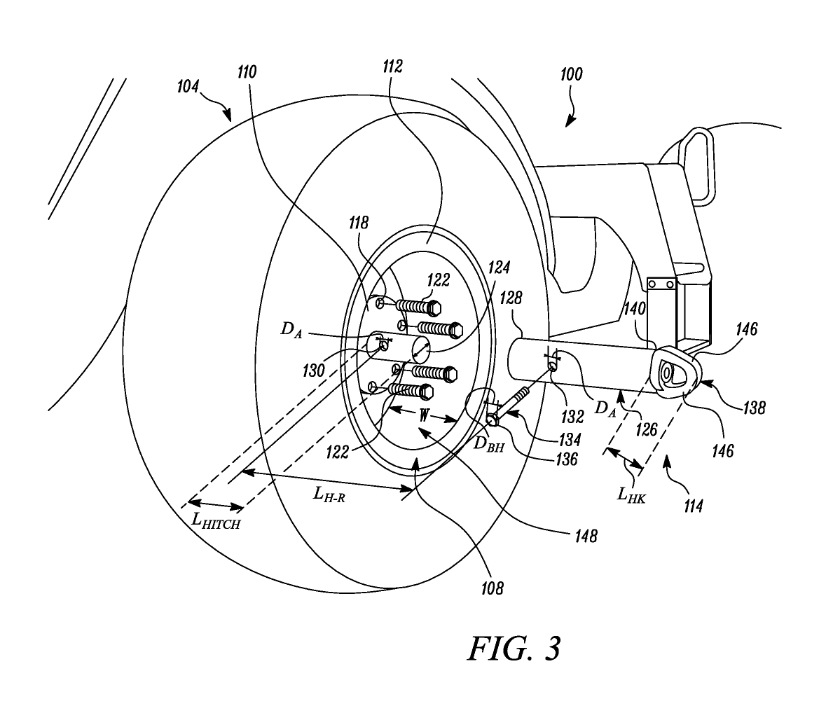

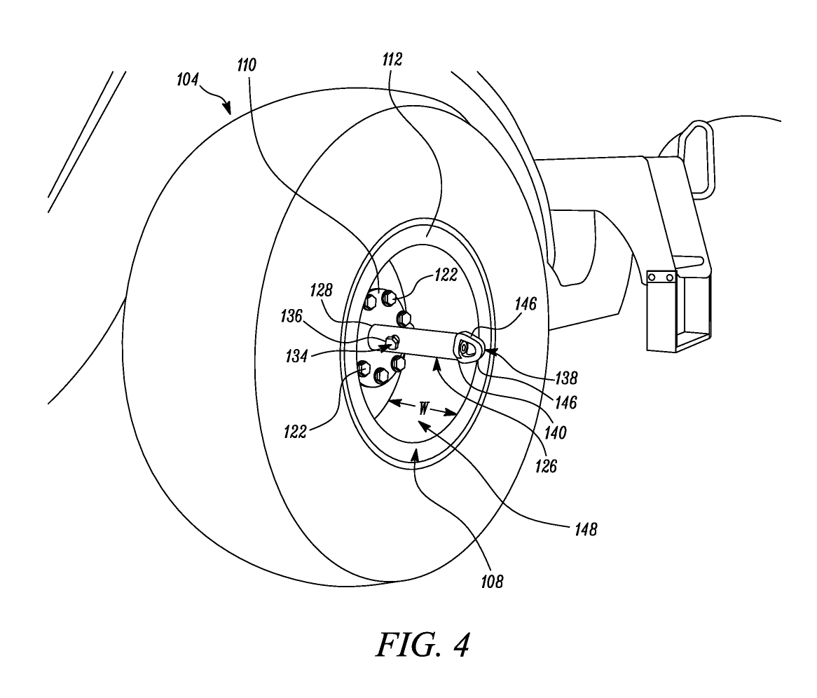

As shown in FIGS. 2-3, the hitch assembly 114 also includes a hitch 124 protruding from the mounting flange 116 and configured to extend longitudinally away from the outer face 110 of the wheel rim 108. Referring to FIGS. 2-4, the hitch assembly 114 further includes an elongated receiver component 126 selectively coupled to the hitch 124 (receiver component 126 shown in a coupled state with the hitch 124 in FIG. 4). The receiver component 126 has a first end 128 adapted to releasably engage with the hitch 124. In one embodiment as shown in FIGS. 2 and 3, each of the hitch 124 and the receiver component 126 include an aperture 130, 132 therein. The apertures 130, 132 of the hitch 124 and the receiver component 126 are configured to be disposed in mutual alignment when the receiver component 126 is slidably received by the hitch 124 to a pre-determined distance disposed at least partway along a length L_{HITCH} of the hitch 124, as mutually defined by the relative locations of the apertures 130, 132 on the hitch 124 and the receiver component 126 respectively.

Referring to FIGS. 2-4, the hitch assembly 114 further comprises a locking pin 134 positioned in the mutually aligned apertures 130, 132 of the hitch 124 and the receiver component 126. The locking pin 134 is configured to restrict a relative movement between the hitch 124 and the receiver component 126. Therefore, the locking pin 134 helps to lock a position of the receiver component 126 on the hitch 124—both longitudinally and rotationally. The locking pin 134 may include for e.g., an elongated stud having a bolt head 136 whose diameter D_{BH} is larger than a diameter D_{A} of the apertures 130, 132. In another example, the locking pin 134 may be embodied in the form of a split pin (not shown) or other equivalent or similar structures known to one skilled in the art.

In yet another embodiment, the locking pin 134 may be embodied in the form of a spring-loaded plunger (not shown) that is disposed partway within the aperture 132. This spring-loaded plunger may be biased by a spring element (not shown) to remain in the open state and can be operated to extend into the aperture 130 of the hitch 124 while in the locked state. Numerous configurations of locking mechanisms can be contemplated by one skilled in the art to establish a selective locking and unlocking of the receiver component 126 to the hitch 124 without deviating from the spirit of the present disclosure.

With continued reference to FIGS. 2-4, the hitch assembly 114 further includes a hook element 138 that is rotatably coupled to a second end 140 of the receiver component 126. The hook element 138 is configured to couple with a hoist 142 for e.g., a cable, a rope, a chain, a link, or other appropriate structures of a hoist system 144 as shown in FIG. 1. As the hook element 138 is free to rotate i.e., swivel about the second end 140 of the receiver component 126, it is envisioned that in some embodiments, arms 146 of the hook element 138 may be closed off, or as shown in FIGS. 2-4—bent to terminate into one another so that the hoist 142 can be prevented from inadvertently becoming uncoupled from the hook element 138. However, other possible shapes and/or configurations of the hook element 138 such as not limited to, partly-open configurations for e.g., open-hook shape may be contemplated by one skilled in the art depending on specific requirements of an application.

In an embodiment as shown in FIG. 2, a combined length C_{L} of the mounting flange 116 and the hitch 124 is lesser than a distance W between the outer face 110 and the outer lip 112 of the wheel rim 108. The terms ‘combined length’ can be regarded as being inclusive of a thickness T_{MF} of the mounting flange 116 and a length L_{HITCH} of the hitch 124. As the receiver component 126 is coupled to the hitch 124, for e.g., before the machine 100 is to be hoisted using the hoist system 144, it is hereby envisioned that when the receiver component 126 is uncoupled from the hitch 124, the combined length C_{L} of the mounting flange 116 and the hitch 124 helps to prevent the hitch 124 from extending past the outer lip 112 of the wheel rim 108 and interfering with other components of the machine 100 and/or objects located in the vicinity of the wheel rim 108. Rather, the combined length C_{L} of the mounting flange 116 and the hitch 124 helps the mounting flange 116 and the hitch 124 to stay within a recess 148 of the wheel rim 108 i.e., in the distance W between the outer face 110 and the outer lip 112 of the wheel rim 108. This way, the mounting flange 116 and the hitch 124 could remain positioned within an outer profile of the machine 100, in this case—at least by a profile defined by the immediately outlying outer lip 112 of the wheel rim 108.

Moreover, in another embodiment as shown in FIG. 4, a total length L_{TOT} of the hitch assembly 114 is greater than the distance W between the outer face 110 and the outer lip 112 of the wheel rim 108. The terms ‘total length’ disclosed herein can be regarded as being inclusive of a thickness T_{MF} of the mounting flange 116; a length L_{H-R} of the hitch 124 and the receiver component 126, as defined by their mutual engagement; and a length L_{HK} of the hook element 138 taken from the second end 140 of the receiver component 126. The total length L_{TOT} of the hitch assembly 114 is selected so as to locate the hook element 138 distally away from the outer lip 112 of the wheel rim 108. Therefore, when the hook element 138 is coupled with the hoist 142 of the hoist system 144 (as shown in FIG. 1), the total length L_{TOT} of the hitch assembly 114 helps to prevent the hoist 142 from interfering or abutting with other components of the machine 100 when the hoist 142 is taut with the hook element 138 and/or while the machine 100 is being hoisted.

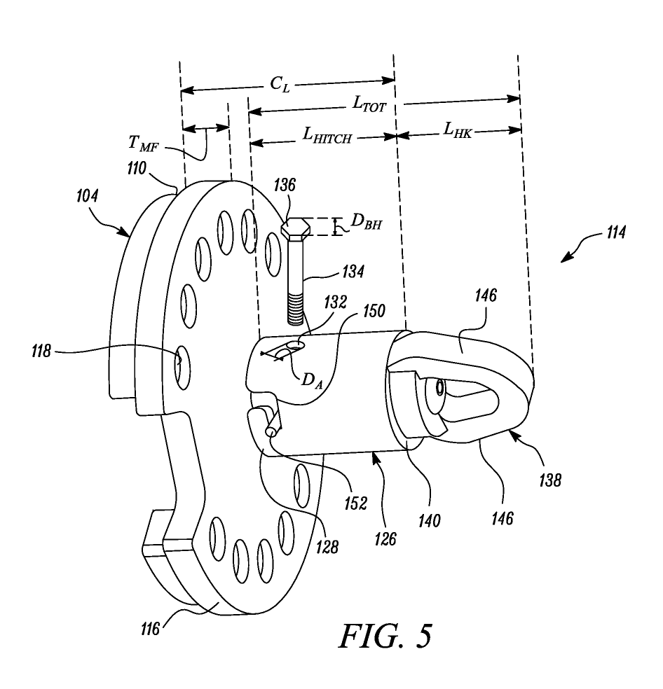

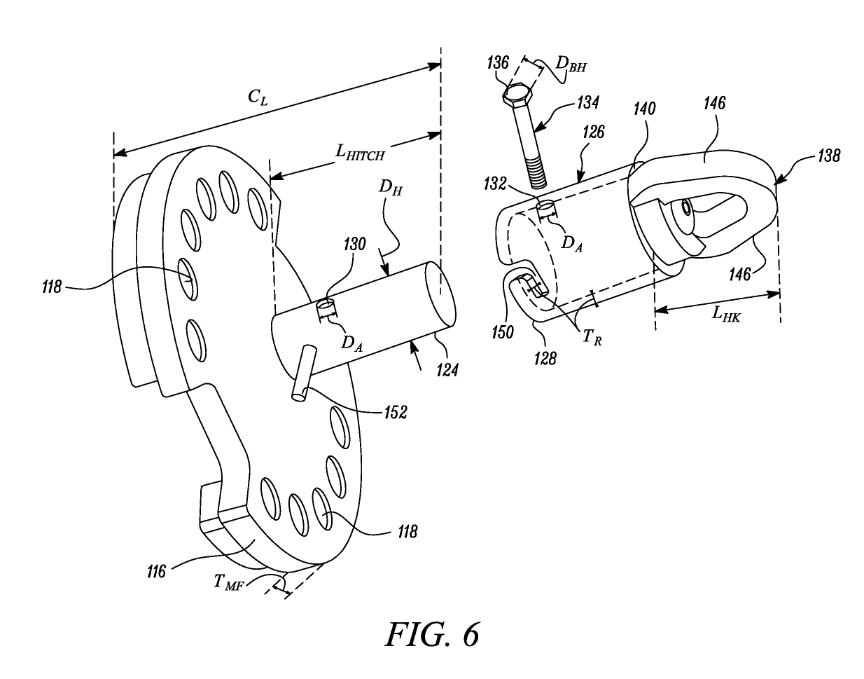

In an embodiment of this disclosure as shown in FIGS. 5-6, it can be contemplated, additionally or optionally, to define a first set of interlocking features 150 on the receiver component 126. The first set of interlocking features 150 may be located proximal to the first end 128 of the receiver component 126 and configured to releasably engage with a second set of interlocking features 152 defined on the hitch 124. In the illustrated embodiment of FIGS. 5-6, the first and second set of interlocking features 150, 152 are together configured to represent a twist-lock mechanism. However, in other embodiments, other types of inter-locking mechanisms can be contemplated in lieu of the twist-lock mechanism. The first and second set of interlocking features 150, 152 assist to serve as a means for additionally securing the receiver component 126 with the hoist 142. Moreover, the first and second set of interlocking features 150, 152 help the operator or technician to locate and align the apertures 130, 132 quickly and with ease for insertion of the locking pin 134 (refer FIGS. 5 and 6) and therefore, couple the receiver component 126 to the hitch 124. Also, in an event of deterioration of the locking pin 134, the first and second set of interlocking features 150, 152 could prevent, at least to some extent, the uncoupling of the receiver component 126 from the hitch 124 as the machine 100 is being hoisted or lowered using the hoist system 144.

In an embodiment as shown in FIG. 6, an outer diameter D_{H} of the hitch 124 and a thickness T_{R} of the receiver component 126 may be additionally configured to provide substantially equal stiffness to the hitch 124 and the receiver component 126 respectively. The equal stiffness of the hitch 124 and the receiver component 126 may offer equal resistances to bending loads encountered by the hitch 124 and the receiver component 126 when hoisting or lowering the machine 100.

It may be noted that in the aforesaid disclosure, the hitch assembly 114 has been explained in conjunction with a single wheel assembly 104 of the machine 100. However, persons skilled in the art will acknowledge that in the case of the machine 100—an irregular object, one hitch assembly 114 would be ideally employed with each of the four wheel assemblies 104 to maintain equilibrium in the balance of the machine 100 as the machine 100 is being raised or lowered. Also, if the center of mass of the irregular object lies towards any one side of the object, then a length L_{HOIST} of the hoist 142 corresponding to each of the hitch 124 assemblies can beneficially be adjusted to regain equilibrium in the balance of the irregular object when hoisted or lowered.

In an embodiment as shown in FIG. 1, the machine 100 may also include a storage holder 154 disposed on the frame 102. The storage holder 154 is configured to accessibly store the receiver component 126 and the hook element 138 thereon when the receiver component 126 is uncoupled from the hitch 124. In the illustrated embodiment of FIG. 1, the storage holder 154 includes four upright arms 156 that can slidably receive up to four hitches 124 corresponding to the four wheel assemblies 104 of the machine 100. However, fewer or more upright arms 156 can be disposed depending on specific requirements of an application. In an alternative embodiment, the storage holder 154 may include four sockets (not shown) in lieu of the four upright arms 156. These sockets can slidably receive and accessibly store the receiver components 126 uncoupled from their corresponding hitches 124. Although the upright arms 156 and sockets are disclosed herein, such configurations of the storage holder 154 is merely exemplary in nature and hence, non-limiting of this disclosure. Therefore, it may be appreciated that the storage holder 154 may be configured in any manner known to persons skilled in the art depending on specific requirements of an application.

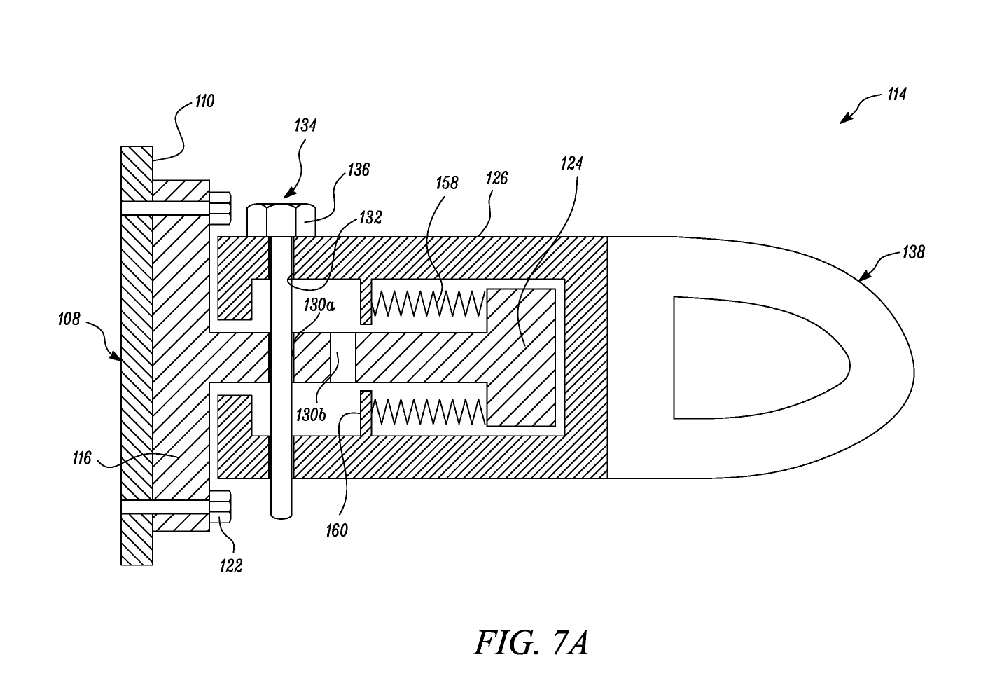

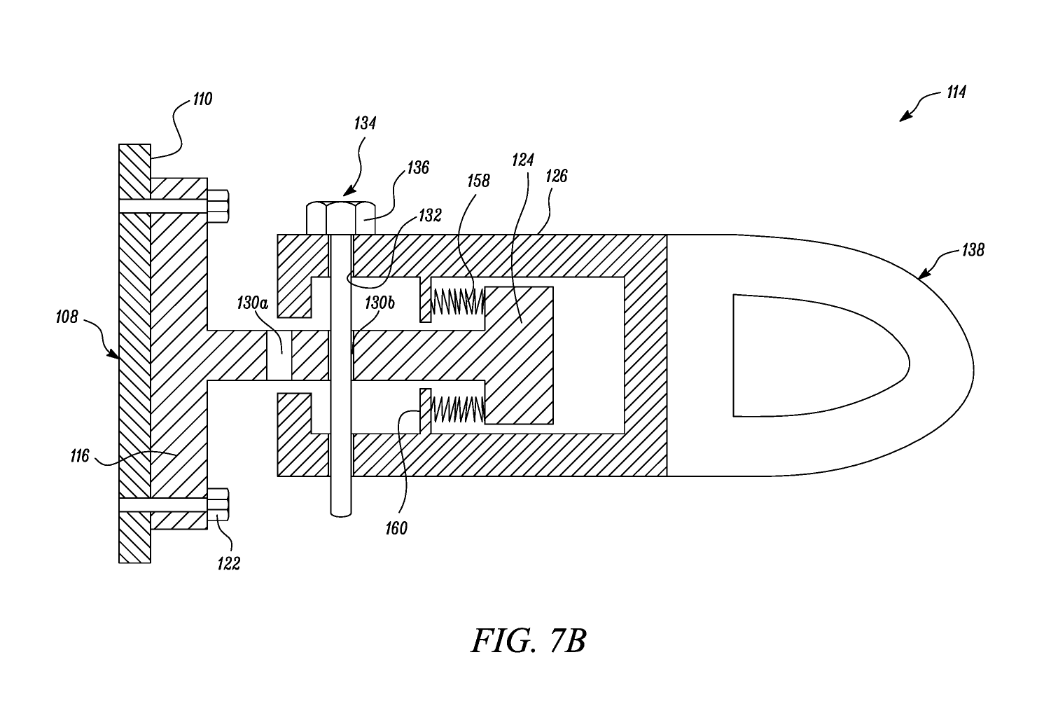

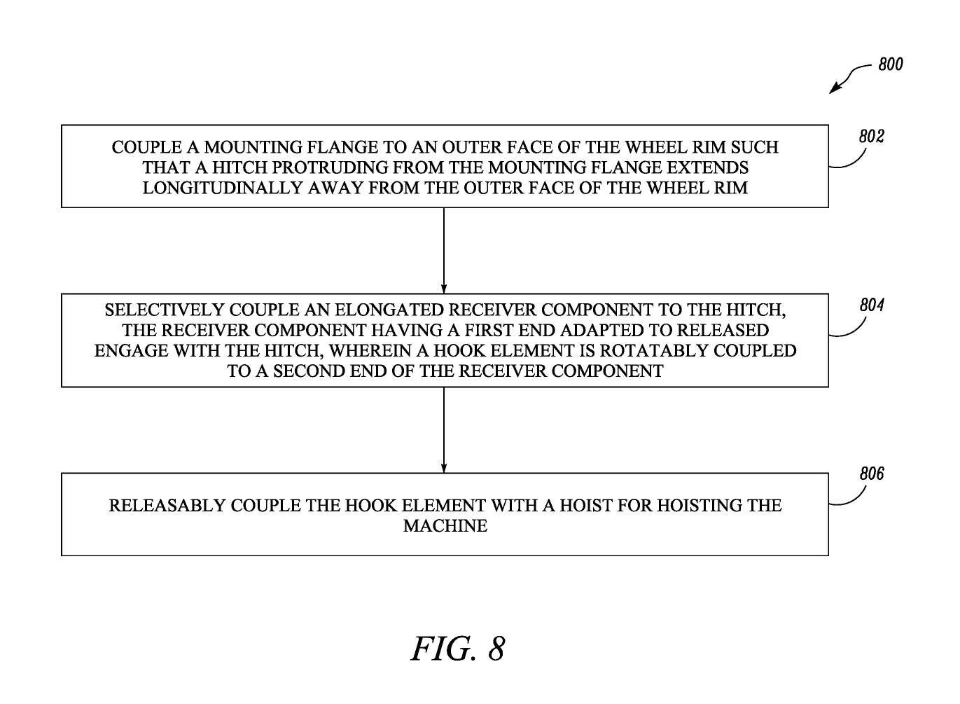

In another embodiment of the present disclosure, the receiver component 126 can be configured to move telescopically with respect to the hitch 124. Specifically, the receiver component 126 can be moved into a retracted position for storage on the machine 100 as shown in FIG. 7a, or extended into a hoisting position for hoisting the machine 100 as shown in FIG. 7b.

Referring to FIGS. 7a-7b, the hitch assembly 114 could further include a stop element 160 that is configured to mutually co-operate with the hitch 124 using a spring element 158. In an embodiment as shown in FIGS. 7a-7b, the spring element 158 is embodied in the form of a compression spring. However, in alternative embodiments, other types of spring elements known in the art may be used in lieu of the compression spring shown in FIGS. 7a-7b. As shown in FIG. 7a, the spring element 158 can assist in biasing the receiver component 126 for allowing an insertion of the locking pin 134 in the mutually aligned apertures 130a, 132 and effecting the receiver component 126 into the retracted position with respect to the hitch 124. Moreover, as shown in FIG. 7b, to use the hitch assembly 114 for hoisting the machine, an operator or technician can remove the locking pin 134 from the mutually aligned holes 130a, 132 of the hitch 124 and the receiver component 126 (shown in FIG. 7a), move the receiver component 126 against a force of the spring element 158 until the apertures 130b, 132 of the hitch 124 and the receiver component are in mutual alignment (shown in FIG. 7b), and re-insert the locking pin into the mutually aligned apertures 130b, 132 of the hitch 124 and the receiver component (as shown in FIG. 7b).

Various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

FIG. 7 illustrates a method 800 of hoisting a machine for e.g., machine 100 having at least one wheel rim for e.g., wheel rim 108. By way of example, the method 800 of FIG. 7 will hereinafter be explained in conjunction with the machine 100 and of FIG. 1 and the hitch assembly 114 of FIGS. 1-4.

At block 802, the method 800 includes coupling the mounting flange 116 to the outer face 110 of the wheel rim 108 such that the hitch 124 protruding from the mounting flange 116 extends longitudinally away from the outer face 110 of the wheel rim 108. At block 804, the method 800 further includes selectively coupling the elongated receiver component 126 to the hitch 124, the first end 128 of the receiver component 126 being adapted to releasably engage with the hitch 124, and wherein the second end 140 of the receiver component 126 rotatably supports the hook element 138 thereabout.

In an embodiment, the method 800 further includes restricting relative movement between the hitch 124 and the receiver component 126 by inserting the locking pin 134. In another embodiment, the method 800 could, additionally or optionally, include providing the first and second set of inter-locking features on the receiver component 126 and the hitch 124 respectively, the first and second set of interlocking features 150, 152 configured to releasably engage with one another to establish a restriction in the relative movement between the hitch 124 and the receiver component 126.

At block 806, the method 800 further includes releasably coupling the hook element 138 with the hoist 142 for e.g., ropes, cables, or links for hoisting the machine 100 (refer to FIG. 1).

Embodiments of the present disclosure have applicability for use and implementation in hoisting or lowering a machine for e.g., a wheeled machine. Moreover, embodiments of the present disclosure also have applicability for use and implementation in lowering material and labor costs incurred in the manufacture and installation of previously known lifting points or fixtures on machines.

The minimal number of parts used to form the hitch assembly 114 can be produced using simple manufacturing processes, such as, but not limited to, turning, extruding, welding, forging and metal-forming. Therefore, the hitch assembly 114 of the present disclosure is simple in design, light-weight, and cost-effective.

Also, as the hitch 124 remains vis-à-vis the mounting flange 116 on the wheel rim 108 for e.g., after the receiver component 126 has been uncoupled from the hitch 124, it is hereby envisioned that little or no dirt or grime would be entrapped onto the hitch 124 due to the hitch 124 exhibiting a protuberance from the mounting plate into the recess 148 of the wheel rim 108. Therefore, cleanliness of the hitch 124 is easily maintained for facilitating subsequent engagement of the receiver component 126 with the hitch 124. Dirt or grime, if any, can be easily and quickly accessed and cleaned off from the hitch 124.

Moreover, with implementation of embodiments disclosed herein, technicians can easily and quickly set up the machine 100 for hoisting. With use of embodiments disclosed herein, technicians can access the required number of receiver components 126 from the storage holder 154 and couple the receiver components 126 to their respective hitches 124. In various embodiments of the present disclosure, the hitch assembly 114 disclosed herein requires little or no modification to the wheel rim 108 to accomplish a coupling with the wheel rim 108. As disclosed earlier herein, in an embodiment, the holes 120 on the wheel rim 108 could be holes that typically receive fasteners for e.g., fasteners 122 for bolting on to the axle hub. Such a configuration could allow one skilled in the art to conveniently retro-fit the present hitch assembly 114 onto existing machines.

While aspects of the present disclosure have been particularly shown and described with reference to the embodiments above, it will be understood by those skilled in the art that various additional embodiments may be contemplated by the modification of the disclosed machines, systems, methods and processes without departing from the spirit and scope of what is disclosed. Such embodiments should be understood to fall within the scope of the present disclosure as determined based upon the claims and any equivalents thereof.

What is claimed is:

1. A hitch assembly for hoisting a machine having at least one wheel rim, the hitch assembly comprising:
a mounting flange configured to be disposed on an outer face of the wheel rim;
a hitch protruding from the mounting flange and extending longitudinally away from the outer face of the wheel rim;
an elongated receiver component selectively coupled to the hitch, the receiver component having a first end adapted to releasably engage with the hitch; and
a hook element rotatably coupled to a second end of the receiver component, the hook element being configured to rotate about the receiver component.

2. The hitch assembly of claim 1, wherein the mounting flange defines holes configured to align with corresponding holes on the wheel rim.

3. The hitch assembly of claim 2 further comprising fasteners received in holes of the mounting flange, the fasteners configured to releasably secure the mounting flange to the wheel rim.

4. The hitch assembly of claim 1, wherein each of the hitch and the receiver include an aperture therein, the apertures from the hitch and the receiver component configured to be disposed in mutual alignment.

5. The hitch assembly of claim 4 further comprising a locking pin positioned in the mutually aligned apertures of the hitch and the receiver component to restrict a relative movement between the hitch and the receiver component.

6. The hitch assembly of claim 1 further comprising a first set of interlocking features disposed on the receiver component, the first set of interlocking features located proximal to the first end of the receiver component and configured to releasably engage with a second set of interlocking features defined on the hitch.

7. The hitch assembly of claim 1, wherein an outer diameter of the hitch and a thickness of the receiver component is configured to provide substantially equal stiffness to the hitch and the receiver component respectively.

8. The hitch assembly of claim 1, wherein a combined length of the mounting flange and the hitch is lesser than a distance between the outer face of the wheel rim and an outer lip of the wheel rim.

9. The hitch assembly of claim 8, wherein a total length of the hitch assembly is greater than the distance between the outer face and the outer lip of the wheel rim, the total length being configured to locate the hook element distally away from the outer lip of the wheel rim.

10. A machine comprising:
a frame;
at least one wheel assembly rotatably supported on the frame, the wheel assembly comprising a wheel rim having an outer face and an outer lip extending angularly away from the outer face; and
a hitch assembly coupled to the wheel rim, the hitch assembly comprising:
a mounting flange configured to be disposed on the outer face of the wheel rim;
a hitch protruding from the mounting flange and extending longitudinally away from the outer face of the wheel rim;
an elongated receiver component selectively coupled to the hitch, the receiver component having a first end adapted to releasably engage with the hitch; and
a hook element rotatably coupled to a second end of the receiver component, the hook element being configured to rotate about the receiver component.

11. The machine of claim 10, wherein the mounting flange defines holes configured to align with corresponding holes on the wheel rim.

12. The machine of claim 11, wherein the hitch assembly further comprises fasteners received in the holes of the mounting flange and the wheel rim, the fasteners configured to releasably secure the mounting flange to the wheel rim.

13. The machine of claim 10, wherein each of the hitch and the receiver include an aperture therein, the apertures from the hitch and the receiver component configured to be disposed in mutual alignment.

14. The machine of claim 13, wherein the hitch assembly further comprises a locking pin positioned in the mutually aligned apertures of the hitch and the receiver component, the locking pin configured to restrict a relative movement between the hitch and the receiver component.

15. The machine of claim 10, wherein the hitch assembly further comprises a first set of interlocking features disposed on the receiver component, the first set of interlocking features located proximal to the first end of the receiver component and configured to releasably engage with a second set of interlocking features defined on the hitch.

16. The machine of claim 10, wherein an outer diameter of the hitch and a thickness of the receiver component is configured to provide substantially equal stiffness to the hitch and the receiver component respectively.

17. The machine of claim 10, wherein a combined length of the mounting flange and the hitch is lesser than a distance between the outer face and the outer lip of the wheel rim.

18. The machine of claim 17, wherein a total length of the hitch assembly is greater than the distance between the outer face and the outer lip of the wheel rim, the total length being configured so as to locate the hook element distally away from the outer lip of the wheel rim.

19. The machine of claim 10 further comprising a storage holder disposed on the frame, the storage holder being configured to accessibly store the receiver component and the hook element thereon when the receiver component is uncoupled from the hitch.

20. A method of hoisting a machine having at least one wheel rim, the method comprising:
coupling a mounting flange to an outer face of the wheel rim, wherein a hitch protrudes from the mounting flange and extends longitudinally away from the outer face of the wheel rim;
selectively coupling an elongated receiver component to the hitch, the receiver component having a first end adapted to releasably engage with the hitch, wherein a hook element is rotatably coupled to a second end of the receiver component; and
releasably coupling the hook element with a hoist for hoisting the machine.
